(19) United States
(12) Patent Application Publication
(10) Pub. No.: US 2007/0056352 A1
(43) Pub. Date: Mar. 15, 2007

(54) Drift compensation for an impedimetric exhaust gas sensor by variable bias voltage

(75) Inventors: Thomas Birkhofer, Immenstaad (DE); Aleksandar Knezevic, Friedrichshafen (DE); Ralf Mueller, Deggenhausertal (DE); Carsten Plog, Markdorf (DE)

Correspondence Address: CROWELL & MORING LLP;INTELLECTUAL PROPERTY GROUP, P.O. BOX 14300, WASHINGTON, DC, 20044-4300, US

(73) Assignee: DAIMLERCHRYSLER AG, Stuttgart (DE)

(21) Appl. No.: 10/563,569

(22) PCT Filed: Jun. 30, 2004
(86) PCT No.: PCT/EP04/07068

§ 371 Date: May 11, 2006

(30) Foreign Application Priority Data
Jul. 7, 2003 (DE) 103 30 742.7

(51) Int. Cl. G01M 15/10

(52) U.S. Cl. 73/23.21; 73/23.31; 73/1.06; 73/1.07

(57) ABSTRACT

An exhaust gas sensor is proposed for detecting a gas component in the exhaust gas of an internal combustion engine, having a control and evaluation unit and a sensor unit with an electrode structure with a first terminal and a second terminal, and a method for operating an exhaust gas sensor to determine the concentration of a gas component in the exhaust gas of an internal combustion engine is also proposed. The control and evaluation unit applies a bias voltage to the first terminal and/or the second terminal of the electrode structure, it being possible for the level of the bias voltage to be set in dependence on a characteristic of the sensor and/or in dependence on a loading of the sensor. A bias voltage is applied to the first terminal and/or to the second terminal of the electrode structure, with the level of the bias voltage being set in dependence on a characteristic of the sensor and/or in dependence on a loading of the sensor.

### BACKGROUND AND SUMMARY OF THE INVENTION

This invention relates to a gas sensor for detecting a gas component in the exhaust gas of an internal combustion engine having a control and evaluation unit, and to a method of operating a gas sensor.

European Patent EP 0 426 989 B1 discloses a gas sensor and an operating method for a gas sensor. The gas sensor has an electrode structure acting as a capacitor, with two terminals. The electrode structure is coated with a sensitive layer. This layer is sensitive to a gas component to be measured, it being possible for the capacitance that changes with the concentration of the gas component to be picked up at the terminals as a measured variable. However, the long-term stability of such a sensor is often unsatisfactory, which is disadvantageous for its use in exhaust gases of internal combustion engines.

The object of the invention is therefore to provide an exhaust gas sensor for detecting a gas component in the exhaust gas of an internal combustion engine and an operating method for an exhaust gas sensor with which great long-term stability is achieved.

This object is achieved by a gas sensor according to the invention.

In the exhaust gas sensor according to the invention, the control and evaluation unit assigned to the exhaust gas sensor applies a bias voltage to the first and/or the second terminal of the electrode structure of the sensor unit. It is possible for the level of the bias voltage to be set in dependence on a characteristic of the sensor and/or in dependence on a loading of the sensor.

The operating conditions in the exhaust gas of an internal combustion engine, characterized by occasional high temperatures and the effect of aggressive gases, represent a loading of the exhaust gas sensor that increases with increasing time and may bring about a change of important sensor characteristics. This may result in aging of the exhaust gas sensor, which has unfavorable effects in particular on the long-term stability of the measured variable that is provided by the sensor unit. In this case, the measured variable is understood as meaning a characteristic of the sensor unit that is dependent on the ambient conditions. This is preferably the complex impedance of the sensor unit or a variable derived from it. Mainly affected by changes are the stability of the zero-point signal and the sensitivity of the exhaust gas sensor with respect to the gas component to be detected. The sensor loading can in this case be quantified for example by the operating time.

Applying a bias voltage to the terminals of the sensor unit as provided by the invention has the effect that the sensor characteristics are stabilized, or effects of the sensor loading or the aging-induced deterioration of the sensor characteristics are compensated. The bias voltage may in this case be an offset voltage applied in addition to the operating voltage or a voltage correcting the operating voltage. The bias voltage can preferably be set in dependence on the deviation of a sensor characteristic from a predetermined or predeterminable setpoint value. The measured variable is preferably adjusted by this settable bias voltage, so that incorrect measurements are avoided even after a long operating time and high sensor loading.

Depending on the configuration of the exhaust gas sensor, the measured variable may be an electromotive force that can be picked up between the terminals of the sensor unit, the complex impedance or a characteristic of the sensor unit that can be derived from it. The measured variable is preferably evaluated by the control and evaluation unit and, after that, the bias voltage to be set is determined and applied to a terminal or to the terminals of the sensor unit. If appropriate, further signals, which are preferably likewise provided by the gas sensor or are picked up at the gas sensor, are likewise evaluated, in order to be able to set the bias voltage correspondingly and use it for example to compensate for a degradation of the gas sensor.

In a refinement of the invention, the level of the bias voltage can be set in dependence on a reference value of the measured variable. The reference value of the measured variable is preferably a value of the measured variable when there is a predeterminable concentration of the gas component to be detected or some other gas component with respect to which there is likewise sensitivity. In the simplest case, the value of the measured variable may serve as the reference value in the absence of the gas component to be detected. The value of the measured variable when there are defined measuring conditions, such as for example a known exhaust gas composition or defined operating state of the internal combustion engine, may likewise serve as the reference value.

In a further refinement of the invention, the level of the bias voltage can be set in dependence on the sensitivity of the sensor unit. Sensitivity is to be understood here as meaning the difference between two associated values of the measured variable in relation to a difference in concentration of a gas component.

In a further refinement of the invention, the level of the bias voltage can be set in dependence on an electrical reference variable that can be measured between the electrode structure of the sensor unit and a circuit of the exhaust gas sensor. The circuit may in this case be, for example, an electrical heater integrated in the exhaust gas sensor or a measuring circuit for measuring a further variable. Circuits of this type are usually integrated in the exhaust gas sensor in such a way that they are electrically insulated from the sensor unit and coupled to the sensor unit via electrical reference variables, such as for example the inductance, capacitance or conductivity, and can influence the value of the measured variable and are likewise subject to aging-induced change. The electrical reference variables are determined and evaluated by the control and evaluation unit. Applying a bias voltage that can be set in dependence on these reference variables to a terminal or the terminals of the sensor unit compensates for the cross-influences and their changes.

In a further refinement, the gas sensor has a circuit for temperature measurement, covered by an insulating layer, the sensor unit being applied to the insulating layer. It is possible for the level of the bias voltage to be set in dependence on an electrical reference variable that can be measured between the electrode structure of the sensor unit and the circuit for temperature measurement. The bias voltage can preferably be set in dependence on the electrical conductivity of the insulating layer. This may be subject to change, for example caused by inward diffusion of foreign atoms, possibly resulting in influencing the measured variable during the operation of the circuit for temperature measurement that changes with operating time or sensor loading. These influences can be counteracted by the bias voltage that can be dependently set for example in dependence on the conductivity between the electrode structure of the sensor unit and the circuit for temperature measurement.

In a further refinement of the invention, the level of the bias voltage can be set in dependence on the operating time of the gas sensor. In this case, it may be advantageous to use the operating conditions, such as the exhaust gas temperature or the concentration of specific exhaust gas components, for weighting.

In a further refinement of the invention, the bias voltage has a positive polarity in relation to an operating voltage of a circuit of the exhaust gas sensor. The operation of an electrical heater or a measuring circuit integrated in the exhaust gas sensor may exert a more or less strong influence on the sensitivity of the exhaust gas sensor or the magnitude of the measured values, depending on the configuration of the exhaust gas sensor or the circuit. By positive pre-polarizing with respect to such a circuit, changed or aging-induced deteriorations of the characteristics of the exhaust gas sensor can be effectively compensated. In this case, the polarity of the bias voltage is preferably positive in relation to the highest potential of the circuit concerned.

In a further refinement of the invention, the exhaust gas sensor is designed for sensing the gas component ammonia. For this purpose, the sensor unit that is exposed to the exhaust gas preferably has an electrode structure configured as a planar interdigital capacitor structure with electrodes engaging in one another in the manner of two combs, and a functional layer applied to it, the electrical conductivity and/or dielectric constant of which is dependent on the ammonia concentration of the exhaust gas. The impedance between the terminals of the sensor unit is determined by the control and evaluation unit, and in this way the concentration of the gas component ammonia in the exhaust gas is determined.

The method according to the invention for operating an exhaust gas sensor is characterized in that a bias voltage is applied to the first and/or the second terminal of the electrode structure of the gas-sensitive sensor unit, the level of the bias voltage being set in dependence on a characteristic of the sensor and/or in dependence on a loading of the sensor. In this case, the corresponding characteristic of the sensor and/or a variable correlating with the sensor loading is preferably determined by the control and evaluation unit assigned to the exhaust gas sensor and the bias voltage is set in a way corresponding to a predetermined relationship. Likewise advantageous is an iteratively performed setting of the bias voltage on the basis of this variable, in order to compensate as far as possible for a change of the sensor characteristics. A self-stabilizing exhaust gas sensor is obtained by this method.

In a refinement of the method, the level of the bias voltage is set in dependence on the zero drift of the electrical measured variable. This measure makes it possible to counteract both the drifting away of the zero-point value of the measured variable and the sensitivity drift of the exhaust gas sensor in the course of the operating time.

In a further refinement of the method, the level of the bias voltage is set in dependence on a sensitivity drift of the exhaust gas sensor. The sensitivity of the exhaust gas sensor is preferably determined from time to time by a control and evaluation unit assigned to the exhaust gas sensor and the bias voltage is changed in a way corresponding to a functional relationship or iteratively in such a way that the sensitivity drift is compensated as far as possible. The sensitivity with respect to the exhaust gas component that is actually to be sensed or alternatively a cross-sensitivity that exists with respect to some other exhaust gas component may be used for this purpose.

In a further refinement of the method, the level of the bias voltage is set at predeterminable points in time. The points in time may be based for example on the operating time. Renewed determination or renewed setting of the bias voltage at equal time intervals of the operation of the sensor, for instance every 10 to 100 hours, is advantageous.

In a further refinement of the method, the level of the bias voltage is set every nth time the exhaust gas sensor is switched on. Renewed determination or renewed setting of the bias voltage each time the exhaust gas sensor is switched on is particularly advantageous. This ensures the reliability of the exhaust gas sensor each and every time it is put into operation.

In a further refinement of the method, the bias voltage is set positively in relation to an operating voltage of a circuit of the exhaust gas sensor that is electrically insulated from the sensor unit. In the case of an exhaust gas sensor of a planar construction, it is particularly advantageous to set the bias voltage positively in relation to an operating voltage of a circuit arranged underneath and insulated from the sensor unit as the uppermost layer.

The invention is explained in more detail below on the basis of drawings and associated examples.

### BRIEF DESCRIPTION OF THE DRAWINGS

FIG. 1 shows a preferred embodiment of the exhaust gas sensor according to the invention represented schematically in an exploded view, and

FIG. 2 is a diagram illustrating a typical change of exhaust gas sensor characteristics.

### DETAILED DESCRIPTION OF THE INVENTION

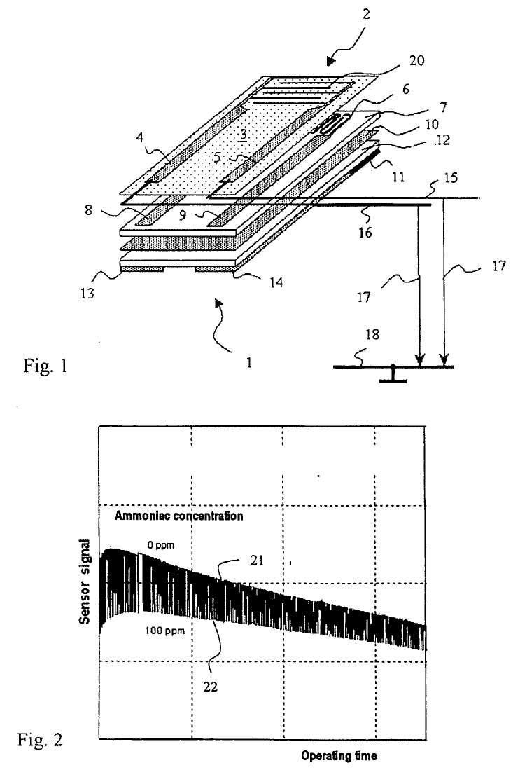

A preferred embodiment of the exhaust gas sensor according to the invention, configured by a planar technique, is explained below on the basis of FIG. 1. The exhaust gas sensor 1 is constructed on a first substrate 12, preferably formed from aluminum oxide ceramic.

Applied to the underside of the first substrate 12 is a heater structure 11 with two associated terminals 13, 14 for the connection of a heating voltage. The heater structure 11 and the terminals 13, 14 are preferably produced by a thick-film technique, alternatively also by a thin-film technique. A second substrate 7, likewise preferably formed from aluminum oxide ceramic, is arranged on the first substrate 12, it being advantageous to provide a preferably closed separating layer 10 of an electrically conductive material between the first substrate 12 and the second substrate 7, as shown in FIG. 1. In this case, a terminal (not represented) for applying an operating voltage to the separating layer 10 may be provided.

A temperature sensor 6, preferably likewise configured in a layer-like manner, with two terminals 8, 9 is applied to the second substrate 7. In this case, it is advantageous to arrange this temperature sensor 6, formed for example as a planar resistance thermometer, over the heater structure 11.

An insulating layer 3, acting in an electrically insulating manner, covers the temperature sensor 6 and the terminals 8, 9. An electrode structure 20, preferably configured as an interdigital structure with conductor tracks engaging in one another in a comb-like manner, with a first terminal 4 and a second terminal 5, is applied to the insulating layer 3, preferably likewise by means of a layer technology. The width of the conductor tracks and their spacing typically lies in the range between 1 μm and 100 μm.

The electrode structure 20 is coated with a functional layer (not represented here), which decisively determines the sensitivity of the exhaust gas sensor 1. The functional layer is preferably formed from a zeolite, the composition and porosity of which is made to match the gas component to be measured. Although the thickness of the functional layer may be up to several tenths of a mm, a thickness in the range from approximately 1 to 50 μm is preferred. The electrode structure 20 with the functional layer covering (not represented) form the sensor unit 2 of the exhaust gas sensor 1. The sensor unit 2 is preferably arranged directly over the temperature sensor 6 of the exhaust gas sensor 1, separated by the insulating layer 3. In this way, the temperature of the sensor unit 2 can be sensed particularly accurately and can be regulated by supplying current to the heater structure 11.

A first supply line 15 and a second supply line 16 are led to a control and evaluation unit (not represented), which supplies the operating voltages necessary for the operation of the exhaust gas sensor 1 to the terminals provided for this purpose and undertakes the evaluation of the electrical measured variable that is present between the first terminal 4 and the second terminal 5 of the electrode structure 20. In particular, a bias voltage 17 that is expediently defined with respect to a ground potential 18 is applied by the control and evaluation unit to the first terminal 4 and/or to the second terminal 5 of the sensor unit 2, which is explained in more detail further below.

The functional principle and the normal operation of the exhaust gas sensor 1 are explained below. It is assumed here that the sensor unit 2 is exposed to the exhaust gas of a spark-ignition/diesel engine (not represented). For the operation of the exhaust gas sensor 1, it is firstly heated up. For this purpose, a heating voltage is applied to the terminals 13, 14 by the control and evaluation unit. In this case, resetting takes place to the predeterminable operating temperature from approximately 300° C. to 800° C. with the aid of the temperature sensor 6 that is likewise connected to the control and evaluation unit. An operating voltage is then applied by the control and evaluation unit to the terminals 4, 5 of the sensor unit 2. This operating voltage is preferably an alternating voltage with a predetermined frequency, which typically lies in the range between 10² Hz and 10⁵ Hz. Preferably serving as the measured variable is the complex impedance of the sensor unit 2, which is determined by the control and evaluation unit, for example by evaluation of the amount and phase of the operating voltage. In the present case, the sensor unit 2 represents a capacitor with the functional layer as the dielectric. The effect of the gas component that is to be determined acting on the functional layer, for example the effect of adsorption or absorption, causes the change of the electrical conductivity and/or of the dielectric constant of the functional layer that is dependent on the concentration of the gas component, which manifests itself in a change in the real part and/or the imaginary part of the complex impedance of the sensor unit 2. By evaluation of this measured variable, the corresponding gas component can therefore be detected by the control and evaluation unit. It goes without saying that the selectivity and the sensitivity of the sensor unit can be influenced in a suitable way by the choice of the material of the functional layer, the frequency of the operating voltage and the type of measured variable evaluation. It is assumed below that the sensor unit is designed for sensing the exhaust gas component ammonia (NH3) and the control and evaluation unit generates a sensor signal correlating with the NH3 concentration in the exhaust gas by means of an impedance measurement. The diagram represented in FIG. 2 illustrates the situation.

In the diagram represented in FIG. 2, the sensor signal generated by the control and evaluation unit from the impedance as the measured variable is plotted as a function of the operating time. In this case, the operating time is plotted on the x-axis with a logarithmic scale. Since the sensor signal results from the measured variable, to simplify matters reference is made below to the sensor signal when the relationship to the measured variable generating the sensor signal is clear. To generate the sensor signal, the exhaust gas sensor 1 or the sensor unit 2 was exposed to exhaust gas which had an ammonia content changing between 0 ppm and 100 ppm in stages based on predetermined time increments. Generated as a consequence was a sensor signal plotted in the diagram of FIG. 2, which has values between an upper limit 21, assigned to the concentration of 0 ppm, and a lower limit 22, assigned to the concentration of 100 ppm.

It is evident from the diagram of FIG. 2, however, that a change of the sensor characteristics that increases with the operating time is taking place, manifested by a lowering both of the upper limit 21 of the sensor signal and of the lower limit 22 of the sensor signal. Moreover, the limits 21, 22 move closer together with increasing operating time, which corresponds to a decreasing sensor sensitivity.

According to the invention, a sensor signal with long-term stability is obtained by applying a bias voltage 17 to the first terminal 4 and/or the second terminal 5 of the sensor unit 2 by the control and evaluation unit. The bias voltage can be set here in dependence on the characteristic of the sensor and/or in dependence on the loading of the sensor, so that sensor behavior with long-term stability, for example with respect to the zero-point signal or the sensitivity, is achieved over the operating time. The bias voltage 17 preferably has a positive polarity with respect to a circuit arranged in relation to the sensor unit 2 under the insulating layer 3, in particular with respect to the circuit 6, 8, 9 of the temperature sensor, and is applied to both terminals 4, 5 of the sensor unit. The temperature sensor circuit 6, 8, 9 is preferably configured as a resistance thermometer which is connected to a constant current source of the control and evaluation unit. The operating voltage of the resistance thermometer in relation to the common ground potential 18 in this case lies in the millivolt range. Consequently, the potential of the corresponding terminals 8, 9 is comparatively low and a bias voltage 17 that is low in relation to this potential may be adequate to achieve the desired sensor stability. The level of the bias voltage preferably lies in the range between 0.1 V and 25 V, with particular preference in the range between 1.5 V and 3.5 V.

If the separating layer 10 is likewise connected to an operating voltage, it is advantageous to choose the polarity of the bias voltage 17 to be positive also in relation to the potential of the separating layer 10.

The level of the bias voltage 17 may be based on a reference value of the sensor signal, for example the zero-point value of the sensor signal. For this purpose, it is advantageous to keep changing the bias voltage 17 continuously or in steps at operating points at which it is ensured that the ammonia content of the exhaust gas is zero or negligible until the sensor signal assumes the predetermined zero-point value. This adjusting setting may be performed every nth time the exhaust gas sensor 1 is switched on. It is advantageous if it is performed every time the exhaust gas sensor 1 is switched on and the set bias voltage 17 remains applied until the exhaust gas sensor 1 is switched off. An analogous procedure may be followed in the case of an operating point at which there is a known ammonia concentration in the exhaust gas as the reference value.

It may also be provided that the level of the bias voltage 17 is set in dependence on the sensitivity of the sensor unit. For this purpose, it is expedient if, when there is a known ammonia concentration, the bias voltage 17 is changed continuously or in steps until the sensor signal assumes the setpoint value for the respective ammonia concentration, predetermined for example in the form of a setpoint characteristic curve. It is likewise advantageous to use a cross-sensitivity of the exhaust gas sensor 1 that may exist in relation to the gas component NH3 that is to be detected with respect to a further exhaust gas component, such as for example water (H2O) or carbon monoxide (CO) for setting the bias voltage 17. This makes use of the finding that the drift of the sensor sensitivity with respect to NH3 is generally parallel to a drift of the sensor cross-sensitivities. Since the H2O or CO concentration in the exhaust gas can be determined on the basis of the engine operating conditions, it is possible in particular when there is a negligible NH3 concentration for the adjustment of the bias voltage 17 to be performed when there are known H2O or CO concentrations in the exhaust gas by bringing the sensor signal to values assigned to these concentrations by changing the bias voltage 17. It is particularly advantageous in this connection to assign predetermined values for the concentration of a gas component with respect to which a cross-sensitivity exists as reference values to specific engine operating conditions and to perform the setting of the bias voltage 17 in a kind of calibration when there is a corresponding engine operating state. If appropriate, stored values for the sensor signal from one or more previous measurements may also be used for this purpose.

It may be expedient, furthermore, to set the level of the bias voltage 17 in dependence on a characteristic of the sensor that changes parallel to the described drift of the sensor signal. A suitable characteristic of the sensor is, for example, a reference variable that can be measured between the electrode structure 20 and the circuit 11, 13, 14 of the heating or the circuit 6, 8, 9 of the temperature sensor, such as in particular the electrical conductivity or the capacitance. The underlying relation may be stored in the control and evaluation unit as a table or as a functional relationship. From time to time or at predetermined regular intervals, the capacitance or the conductivity between the electrode structure 20 and the temperature sensor 6 is determined for example by the control and evaluation unit and the bias voltage is set in a way corresponding to the stored relationship.

Furthermore, it may be envisaged to determine the influence of the loading of the sensor on the stability of the sensor signal and to set the bias voltage in dependence on the sensor loading. The product of the ammonia concentration and measuring time at the corresponding ammonia concentration (ppm * h) may be used for example for characterizing the sensor loading. It is likewise expedient to use the product of the exhaust gas temperature and the operating time. If appropriate, linear or non-linear correction factors may be additionally taken into account. In the simplest case, the operating time may serve as a measure of the sensor loading and the bias voltage may be set on the basis of a predetermined dependence that is available to the control and evaluation unit. In the way described, it is possible to achieve a reliable and stable measuring behavior of the exhaust gas sensor 1 or of the sensor signal over a long time.

It goes without saying that the stated measures can be used both individually and in combination. It also goes without saying that the stated measures can also be used in modified embodiments of exhaust gas sensors.

1-14. (canceled)

15. A gas sensor for detecting a gas component in the exhaust gas of an internal combustion engine, comprising:
a control and evaluation unit, and
a sensor unit with an electrode structure, a first terminal, and a second terminal,
wherein an electrical measured value present between the first terminal and the second terminal of the electrode structure is adapted to be supplied to the control and evaluation unit to determine the concentration of the gas component,
wherein the control and evaluation unit applies a bias voltage to at least one of the first terminal and the second terminal of the electrode structure,
wherein the bias voltage has a level which is settable in dependence on at least one of a characteristic of the sensor and a loading of the sensor in such a way that sensor behavior with long-term stability is achieved over the operating time.

16. The gas sensor as claimed in claim 15, wherein the level of the bias voltage can be set in dependence on a reference value of the measured value.

17. The gas sensor as claimed in claim 15, wherein the level of the bias voltage can be set in dependence on a sensitivity of the sensor unit.

18. The gas sensor as claimed in claim 15, wherein the level of the bias voltage can be set in dependence on an electrical reference variable that can be measured between the electrode structure of the sensor unit and a circuit of the gas sensor.

19. The gas sensor as claimed in claim 18, further comprising a circuit for temperature measurement covered by an insulating layer, wherein the sensor unit is applied to the insulating layer, and wherein it is possible for the level of the bias voltage to be set in dependence on an electrical reference variable measurable between the electrode structure of the sensor unit and the circuit for temperature measurement.

20. The gas sensor as claimed in claim 15, wherein the level of the bias voltage can be set in dependence on the operating time of the gas sensor.

21. The gas sensor as claimed in claim 15, wherein the bias voltage has a positive polarity in relation to an operating voltage of a circuit of the exhaust gas sensor.

22. The gas sensor as claimed in claim 15, wherein the gas component sensed is ammonia.

23. The gas sensor as claimed in claim 15, wherein said stability is stability with respect to at least one of a zero-point signal and sensitivity.

24. The gas sensor as claimed in claim 16, wherein the level of the bias voltage can be set in dependence on a sensitivity of the sensor unit.

25. The gas sensor as claimed in claim 16, wherein the level of the bias voltage can be set in dependence on an electrical reference variable that can be measured between the electrode structure of the sensor unit and a circuit of the gas sensor.

26. The gas sensor as claimed in claim 17, wherein the level of the bias voltage can be set in dependence on an electrical reference variable that can be measured between the electrode structure of the sensor unit and a circuit of the gas sensor.

27. The gas sensor as claimed in claim 16, wherein the bias voltage has a positive polarity in relation to an operating voltage of a circuit of the exhaust gas sensor.

28. The gas sensor as claimed in claim 16, wherein the gas component sensed is ammonia.

29. A method for operating an exhaust gas sensor to determine a concentration of a gas component in exhaust gas of an internal combustion engine, the exhaust gas sensor including a gas-sensitive sensor unit with an electrode structure with a first terminal and a second terminal, an electrical measured variable correlating with the concentration of the gas component being picked up between the first terminal and the second terminal of the electrode structure, comprising:
applying a bias voltage to at least one of the first and second terminals of the electrode structure,
setting a level of the bias voltage in dependence on at least one of a characteristic of the sensor and a loading of the sensor in such a way that sensor behavior with long-term sensor stability is achieved over an operating time.

30. The method as claimed in claim 29, wherein the level of the bias voltage is set in dependence on a zero-point drift of the electrical measured variable.

31. The method as claimed in claim 29, wherein the level of the bias voltage is set in dependence on a sensitivity drift of the exhaust gas sensor.

32. The method as claimed in claim 29, wherein the level of the bias voltage is set at predeterminable points in time.

33. The method as claimed in claim 29, wherein the level of the bias voltage is set every nth time the exhaust gas sensor is switched on.

34. The method as claimed in claim 29, wherein the bias voltage is set positively in relation to an operating voltage of a circuit of the exhaust gas sensor that is electrically insulated from the sensor unit.

35. The method as claimed in claim 29, wherein said stability is stability with respect to at least one of a zero-point signal and sensitivity.
